(19) United States
(12) Patent Application Publication
(10) Pub. No.: US 2014/0165102 A1
(43) Pub. Date: Jun. 12, 2014

(54) ELECTRONIC PROGRAM LISTINGS DISPLAYING DEVICE

(71) Applicant: Funai Electric Co., Ltd., Osaka (JP)

(72) Inventor: Makoto Date, Osaka (JP)

(73) Assignee: FUNAI ELECTRIC CO., LTD., Osaka (JP)

(21) Appl. No.: 14/046,080

(22) Filed: Oct. 4, 2013

(30) Foreign Application Priority Data
Dec. 7, 2012 (JP) 2012-268118

(51) Int. Cl. H04N 21/482

(52) U.S. Cl. CPC H04N 21/482
USPC 725/39

(57) ABSTRACT

An electronic program listings displaying device includes a program listings displaying portion that displays program listings based on electronic program guide data that includes broadcasting channel names and broadcast times for broadcast programs from individual broadcasting stations, a selection evaluating portion that evaluates a broadcasting station or broadcast program selected in the program listings, and a multichannel displaying portion that displays multichannel broadcast program information relating to the broadcasting station or broadcast program evaluated by the selection evaluating portion.

### FIELD OF TECHNOLOGY

The present invention relates to a technology for displaying program listings for broadcast programs based on electronic program guide data.

### BACKGROUND ART

In television broadcasting, for example, digital broadcasting is becoming more common, and high-definition/high-fidelity programs are broadcasted through digital video and audio signals.

Moreover, electronic program guide (EPG) services are also provided. A television broadcast receiver such as a television receiving device or a television broadcast recording/playing device, or the like, receiving electronic program guide data enables the user to select the broadcast programs easily through displaying, on the screen, broadcast program listings that display broadcast program names in a format wherein they are associated with broadcasting station names and broadcasting times.

In the broadcast receiving device set forth in Patent Citation 1, if, when electronic program guide (EPG) data is received, a given program exists only once within a given time band, that an EPG of a normal format, wherein the program content is displayed for each individual channel, is produced. On the other hand, if a given program exists more than once, then an EPG table having a format wherein the given program detail is displayed once in a given region across a plurality of channels is produced. Given this, the EPG table that has been produced is stored in preparation for a display request.

In the broadcast receiving device set forth in Patent Citation 2, digital broadcast listing information is received and an evaluation is made as to whether or not a broadcast to be received is of multichannel programming within a first threshold time, and if the evaluation is that it is of multichannel programming within the first threshold time, then notification is provided that multichannel broadcasting will be received.

The video displaying device as set forth in Claim 3 is a video displaying device for receiving so-called “multichannel broadcasts” that are mixtures of SD digital broadcasts and HD digital broadcasts, wherein, when displaying a program schedule list for a specified time band, a check is performed as to whether or not there are broadcasting stations wherein a plurality of SD broadcasts are broadcasted simultaneously. Given this, if there are no broadcasting stations included wherein a plurality of SD broadcasts are broadcasted simultaneously, then the display is with a single-unit display cell for each of the programs that are broadcasted by each individual broadcasting station, but if a broadcasting station is included wherein a plurality of programs of SD broadcasts are broadcasted simultaneously, then the single unit display cell is assigned to programs for each channels for a single SD broadcast for which there is simultaneous broadcasting, to display the program schedule list on the displaying portion of the video displaying device.

In the digital broadcast content displaying device set forth in Patent Citation 4, the respective program information wherein there is a mixture of SD broadcast programs and HD broadcast programs, which are characteristic of digital television broadcasts, the respective program information area for SD broadcasts that are overlapping at a given time are surrounded by a cell for highlighted display, rather than just being displayed by the simple list-type EPG screen.

In the electronic program displaying device described in Patent Citation 5, in order to ameliorate problems with performing at EPG display of a BS digital television broadcast using the existing EPG format, when there is an HDTV broadcast when a digital television broadcast is received, the individual channels that handle it are combined for processing the by the control circuit, to display the individual channels in the form of a single channel on the television receiving device through an OSD circuit.

In the broadcast content displaying device described in Patent Citation 6, when the EPG display mode is actuated, the host CPU temporarily stores program information, separated by a demultiplexer, into a main memory, and reads in only those program information that are required again in the EPG display, and controls a graphic generating portion or backend processor, or the like, to display the EPG screen with an OSD display. At this time, the host CPU displays an EPG screen that, for the broadcasting station direction, is structured primarily from display cells of a display size that is based on SD broadcasts, where program information for HD broadcasts and multi-SD broadcasts is displayed with a display size of a portion equivalent to the number of channels in the SD broadcasts that are used for the HD broadcasts, where information indicating the broadcast format is displayed in each individual cell.

### PRIOR ART CITATIONS

### Patent Citations

[Patent Citation 1] Japanese Unexamined Patent Application Publication 2009-225486
[Patent Citation 2] Japanese Unexamined Patent Application Publication 2009-135646
[Patent Citation 3] Japanese Unexamined Patent Application Publication 2008-258959
[Patent Citation 4] Japanese Unexamined Patent Application Publication 2006-050507
[Patent Citation 5] Japanese Unexamined Patent Application Publication 2001-186436
[Patent Citation 6] Japanese Unexamined Patent Application Publication 2000-152114

In digital broadcasts that are able to transmit high density information it is possible to broadcast programs by mixing and combining high image quality HD (High Definition) broadcasts and standard quality SD (Standard Definition) broadcasts.

Doing so makes it possible to perform multichannel broadcasting of the various types of broadcasting formats in each broadcast channels such as having an HD broadcast on a single channel in a given time band, and SD broadcasts of two or more channels during different time bands.

In a digital broadcast that mixes HD broadcasts and SD broadcast in this way, the format of the broadcast program listings that are displayed on the screen through the electronic program guide data uses either:

(1) provision of cells displaying the broadcast program name for each individual SD broadcasts channel for a program listings with the multichannel broadcast as the basis, to display, in these cells, the program names of the HD broadcasts and the program names of the SD broadcasts, or

(2) the provision of one cell for displaying the broadcast program name in the program listings, using the HD broadcasts as the basis, to display the program name of the HD broadcast or the program name of a single SD broadcast in the cell.

However, in the former (1) format, complex cells are provided even for HD broadcasts wherein a single cell displaying the broadcast program name would be adequate, and thus the program listings is larger, and is difficult for the user to read.

On the other hand, in the latter (2) format, even though there are the benefits of having the program listings be more compact and being easy to read even on a small screen, it is not easy to discern visually whether or not the program is a multichannel broadcast.

### SUMMARY OF THE INVENTION

One or more embodiments of the present invention can display a program listing on a screen that is easily read by the user and wherein the program names can be discerned easily event for multichannel broadcasts.

The electronic program listings displaying device according to one or more embodiments of the present invention may comprise a program listings displaying portion that displays program listings based on electronic program guide data that includes broadcasting channel names and broadcast times for broadcast programs from individual broadcasting stations; a selection evaluating portion that evaluates a broadcasting station or broadcast program selected in the program listings; and a multichannel displaying portion that displays multichannel broadcast program information relating to the broadcasting station or broadcast program evaluated by the selection evaluating portion.

For example, in a case wherein there is a mixture of HD broadcasts and SD broadcasts, normally a single cell displaying the broadcast program name in the program listings is provided using the HD broadcast as the basis, where either the HD broadcast program name or the program name of one SD broadcast is displayed in the cell, so the program listings is displayed on the screen in a compact format.

Moreover, in response to a selection, by a user, of a broadcasting station or a broadcast program in the program listings, if there is a related multichannel broadcast for the selected broadcasting station or broadcast program, then the program information for the multichannel broadcast (for example, the program names in the multichannel broadcast) may be displayed on the screen.

As an example of this screen display, when the user selects a broadcasting station or broadcast program in the program listings, the program listings for the name of a broadcast program that is a multichannel broadcast, for the applicable broadcasting station or broadcast program will be displayed at some position on the screen that usually displays the program listings, in any of a variety of formats, such as a separate window or a balloon window, making it easy for the user to check the programs in the multichannel broadcast.

In one or more embodiments of the present invention, the multichannel displaying portion may display the multichannel broadcast program information adjacent to the broadcasting station or broadcast program evaluated by the selection evaluating portion.

As a result, it is possible for a user to visually check intuitively which broadcast channels or broadcast programs are multichannel broadcasted.

The state wherein the relevant multichannel broadcast program information is displayed may be, for example, a multichannel displaying portion displaying, on the screen, multichannel-broadcasted broadcast program names in the form of a grid of the broadcasting station names and the broadcast times.

Moreover, in one or more embodiments of the present invention, the multichannel displaying portion may not display the multichannel broadcast program information when the broadcast program evaluated by the selection evaluating portion is identical to the multichannel broadcast program.

This makes it possible to avoid displaying redundant broadcast programs.

Moreover, in one or more embodiments of the present invention, the multichannel displaying portion may display multichannel broadcast program information of a same time band as the broadcast program evaluated by the selection evaluating portion.

This makes it possible to display whether or not there is multichannel broadcasting and program information for multichannel broadcasts.

Moreover, in one or more embodiments of the present invention, the multichannel displaying portion may display, across specific broadcasting times, multichannel broadcast program information relating to the broadcasting station evaluated by the selection evaluating portion.

This makes it possible to display multichannel broadcast program information related to a selected broadcast channel across specific broadcast times that are, for example, all of the broadcast times for a broadcast channel displayed in the program listings. That is, this makes it possible to display multichannel broadcast program information for a broadcast time width that is set through the device settings or a user operation.

Furthermore, in one or more embodiments of the present invention, the multichannel displaying portion may display multichannel broadcast program information starting with a starting time for a broadcast program evaluated by the selection evaluating portion.

This makes it possible to display program information for multichannel broadcasts that can be viewed in the future.

Moreover, in one or more embodiments of the present invention, the multichannel displaying portion may emphasize display of a display cell that displays multichannel broadcast program information.

This makes it easy for a viewer to check visually for the existence of a relevant multichannel broadcast program, and the information related thereto.

Moreover, in one or more embodiments of the present invention, the multichannel displaying portion may display the multichannel broadcast program information using a semi-transparent or transparent displaying portion.

This makes it possible to display also other program information that is covered, through displaying the program information for multichannel broadcasts.

Moreover, in one or more embodiments of the present invention, the multichannel displaying portion may display the multichannel broadcast program information on a side of the selected broadcasting station or broadcast program from which the cursor was moved in.

This makes it possible for a user that is operating a cursor to anticipate to the position at which the multichannel broadcast program information will be displayed.

In one or more embodiments, the present invention can be embodied as a television receiver provided with an electronic program listings displaying function.

In one or more embodiments, the present invention can also be embodied as a television broadcast recording/playing device, known as a recorder/player, such as an HDD, DVD, or the like, that is equipped with an electronic program listings displaying function, and the television broadcast recording/playing device can use the screen of a connected television receiving device as a monitor screen.

While the present invention typically is adapted to multichannel programming wherein there is a mixture of HD broadcasting and SD multichannel broadcasting, it is not limited to HD broadcasting and SD broadcasting, of course, but, depending on variations in the television broadcasting protocols, and the like, the present invention can be adapted to multichannel broadcasting that is a mixture of a single-channel broadcasting protocol and a multichannel broadcasting protocol.

### BRIEF DESCRIPTIONS OF THE DRAWINGS

FIG. 1 is a diagram illustrating a television receiver and television broadcast recording/playing device according to one or more embodiments of the present invention.

FIG. 2 is a structural diagram of the critical portions of an electronic program listings displaying device according to one or more embodiments of the present invention.

FIG. 3 is a diagram for explaining the program listings displaying procedure according to one or more embodiments of the present invention.

FIG. 4 is a diagram illustrating a program listing that is displayed on a screen according to one or more embodiments of the present invention.

FIG. 5 is a diagram illustrating one example of a program display relating to multichannel broadcasting displayed on a screen according to one or more embodiments of the present invention.

FIG. 6 is a diagram illustrating one example of a program display relating to multichannel broadcasting displayed on a screen according to one or more embodiments of the present invention.

FIG. 7 is a diagram illustrating one example of a program display relating to multichannel broadcasting displayed on a screen according to one or more embodiments of the present invention.

FIG. 8 is a diagram illustrating one example of a program display relating to multichannel broadcasting displayed on a screen according to one or more embodiments of the present invention.

FIG. 9 is a diagram for explaining one example of a program display relating to multichannel broadcasting displayed on a screen according to one or more embodiments of the present invention.

### DETAILED DESCRIPTION OF THE INVENTION

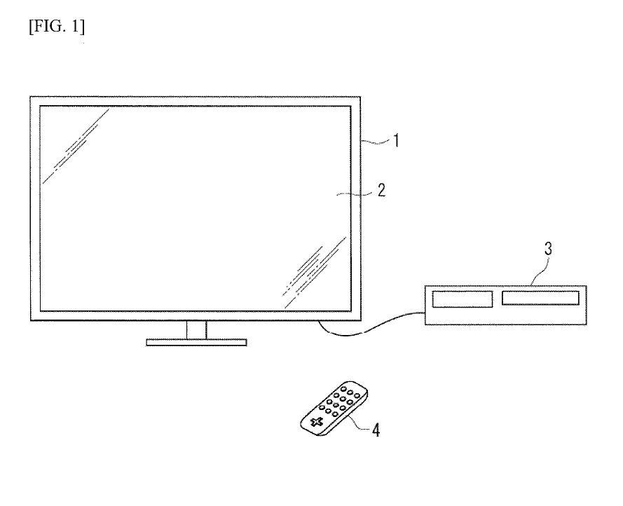

An external view of a television receiving device 1 and a television broadcast recording/playing device 3 that apply an electronic program listings displaying device according to one or more embodiments of the present invention is illustrated in FIG. 1.

The television receiving device 1 receives a digital broadcast through an antenna, and for a broadcast program outputs the audio from a speaker and outputs the video from a screen 2.

The television broadcast recording/playing device 3 may be connected to the television receiving device 1, and may record, onto a recording medium, either a digital broadcast received by the television receiving device 1 or a digital broadcast program received by the television broadcast recording/playing device 3 itself, in a form that can be played back.

The television receiving device 1 and the television broadcast recording/playing device 3 can not only receive user operation inputs from operating portions, such as operating buttons, equipped therein, but can also receive user operation inputs through receiving signals from a remote control 4.

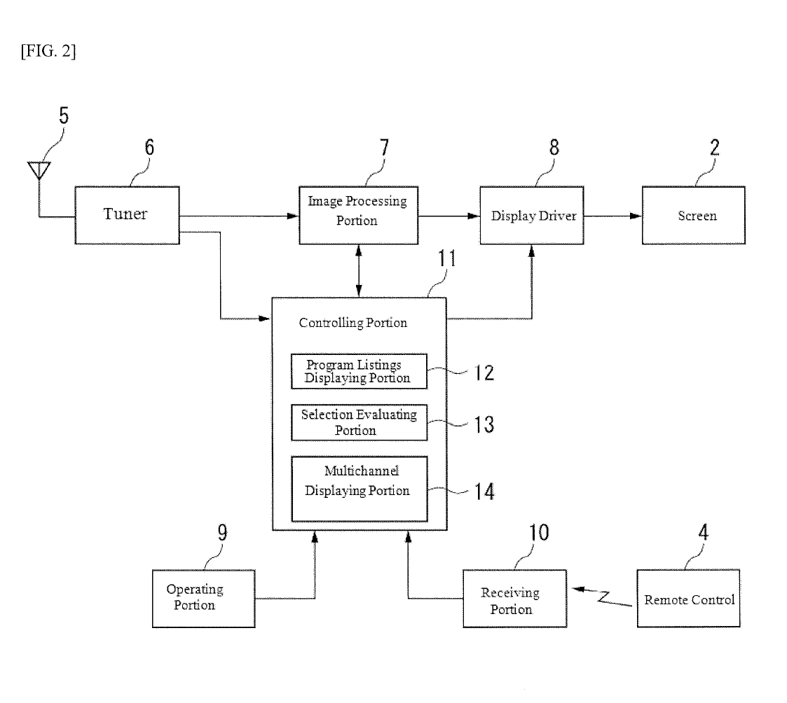

FIG. 2 illustrates, in accordance with one or more embodiments of the present invention, an electronic program listings displaying device that is provided integrally with a television receiving device 1.

This electronic program listings displaying device may have an antenna 5, a tuner 6, an image processing portion 7, a display driver 8, an operating portion 9, a receiving portion 10, and a controlling portion 11.

The antenna 5 receives electronic program guide data together with digital broadcasts, and the tuner 6 performs a procedure for receiving the digital broadcasts and the electronic program guide data.

The image processing portion 7 performs procedures such as video decoding of a digital broadcast that has undergone the receiving procedure, and the display driver 8 displays, on a screen 2, program video in accordance with the digital broadcast.

The controlling portion 11 performs control procedures relating to displaying the program listings, in accordance with user operations inputted from the operating portions 9 and user operations inputted from the remote control 4 through the receiving portion 10.

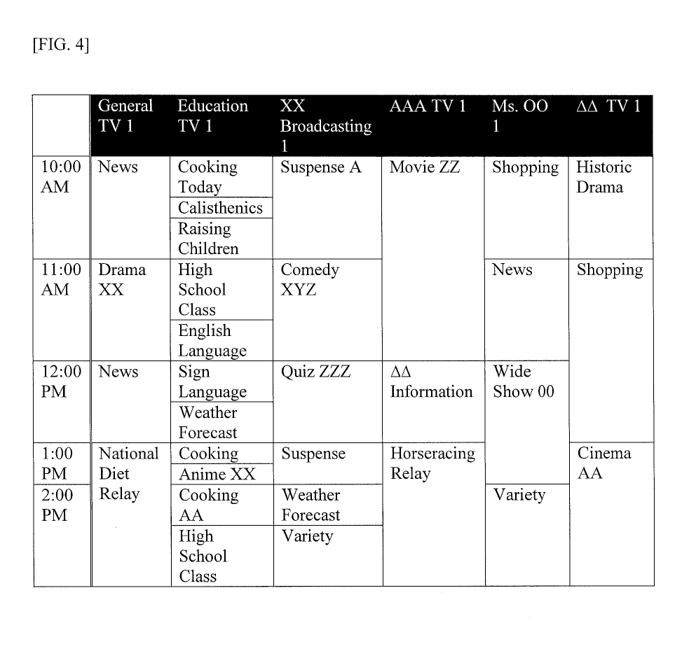

For these control procedures in relation to the display of the program listings, the controlling portion 11 may have a program listings displaying portion 12 for performing procedures for displaying normal program listings (referencing FIG. 4) on the screen 2, a selection evaluating portion 13 for evaluating which of the broadcasting stations or broadcast programs in the normal program listings, displayed on the screen 2, has been selected by a user operation, and a multichannel displaying portion 14 for performing a procedure for displaying, on the screen 2, program listings relating to multichannel broadcasts, in accordance with a selection that has been evaluated by the selection evaluating portion 13.

Here, in the explanation relating to one or more embodiments of the invention in the present application, “selecting” and “okaying” refer to operations of different stages, where a user operation that places the cursor in an area wherein a broadcasting station name or broadcast program name is displayed in the program listings, or that highlights that region, is referred to as “selecting” where a user operation to confirm a selection through further operating a button in relation to a region that has been selected is referred to as “okaying.” For example, it is possible to switch between programs to view by highlighting a cell wherein another program name is displayed in the program listings, displayed on the screen 2, and then pressing an Okay button.

Broadcasting station names, channel names assigned to the individual broadcasting stations, program information for the individual channels, and the like, depending on multichannel program of broadcast programs, may be included in the electronic program guide data, where the starting times, broadcast lengths, program names, and the like, of the programs are included in the multichannel programming. For example, in the case of a program schedule that is a mixture of one HD broadcast channel and three SD broadcast channels, information for the program that is HD-broadcasted and information for the programs for each individual channel of the SD broadcasts that are multichannel-broadcasted are included.

The controlling portion 11 performs a procedure for displaying, on the screen 2, a normal program listing and a program display relating to multichannel broadcasting, based on the electronic program guide data that has been received and processed by the tuner 6 through the antenna 5.

The program listing displaying portion 12 generates a normal program listing in a specific format based on the electronic program guide data, and displays the generated program listings through the display driver 8 on the screen 2.

The normal program listings in the present example, as illustrated in FIG. 4 assigns, for each of the individual broadcasting stations such as “General Television,” “Education TV,” “xx Broadcasting,” “AAA Television,” “Ms. OO,” “ΔΔ TV,” or the like, individual broadcasting station names of “General Television 1,” “Education TV 1,” “xx Broadcasting 1,” “AAA Television 1,” “Ms. OO 1,” “ΔΔ TV 1,” and displays them in the horizontal axial direction, and displays broadcast times (from 10:00 AM until 2:00 PM, in the example that is illustrated) in the vertical axial direction, and in the cells in the table format formed by the broadcasting station names and the broadcast times, displays broadcast program names such as “News,” “Weather Forecast,” “Quiz ZZZ,” “Horse Racing Relay,” “Variety,” “Cinema AA,” and the like.

Embodiments of the invention according to the present application is not limited to a program listings display in a table format as described above, but rather can be applied to program listings in a variety of formats.

In one or more embodiments, even if there is multichannel broadcasting for a given broadcasting station or broadcast program, the program name of the first channel thereof may be displayed, as illustrated in FIG. 4.

Consequently, for multichannel programming that is a mixture of one HD broadcast channel and three SD broadcast channels, for example, the program name will be displayed for the HD broadcast wave, and the program name for the first channel will be displayed for the SD broadcasts, in the broadcast time band cell, causing the display format to be compact overall.

The selection evaluating portion 13 evaluates which of the broadcasting stations or broadcast programs has been selected by a user operation in the normal program listing (FIG. 4) that is displayed on the screen 2 through a user operation inputted from the operating portion 9 or a user operation inputted from the remote control 4 through the receiving portion 10.

In the present example, when there is a selection through a user operation in the normal program listings, the cell for the individual broadcasting station name or individual broadcast program name that has been selected will be highlighted.

The multichannel displaying portion 14, in response to a selection of a broadcasting station or broadcast program by a user, detects, based on the electronic program guide data, whether or not there is multichannel broadcasting in relation to the selected broadcasting station or broadcast program, and if there is multichannel broadcasting, performs a procedure such as displaying, on the screen, program information for the multichannel broadcasts. For example, a procedure for displaying, in the form of a table formed from the broadcasting channel names and broadcasting times, on the screen 2, the program names for the broadcast programs that are multichannel-broadcasted.

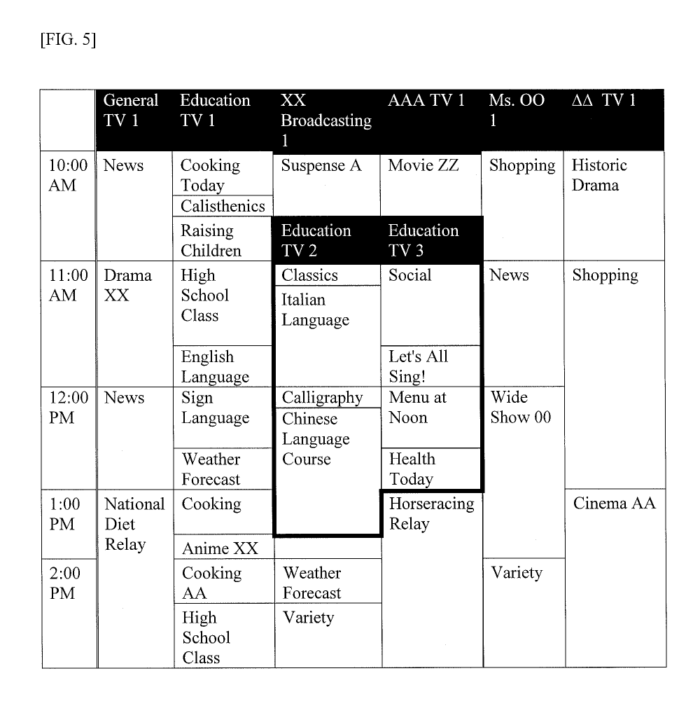

The display of the multichannel-broadcast program information is, for example, a display of the broadcast program names relating to the multichannel broadcasting in a sub-window in a table format that is similar to that of the normal program display, where this may be in a state wherein the sub-window overlaps the normal program display in an arbitrary location on the screen 2, or, as illustrated in FIG. 5 through FIG. 9, in a state wherein the broadcast program names relating to the multichannel broadcast are displayed overlapping the normal program listings on the screen 2 adjacent to the program listing of the selected broadcasting station or broadcast program.

Moreover, the multichannel displaying portion 14 can perform the program information of the multichannel broadcast through a variety of methods or forms, where these methods and forms according to one or more embodiments of the present invention will be explained referencing FIG. 5 through FIG. 9.

The displays of the program information for the multichannel broadcast in the examples illustrated in FIG. 5 through FIG. 9 display the names of the multichannel-broadcasted broadcast programs on the screen 2 in the form of a table formed by the broadcasting channel names and the broadcasting times, and when there are three channels of SD broadcasts, the name of the broadcast program for each individual channel is displayed on the screen 2 in the form of a table with a horizontal axis and a vertical axis, the same as in the normal program listings.

The example illustrated in FIG. 5 is for the case wherein the cell for “Education TV 1,” which indicates the “Education TV” broadcasting station, has been selected in the normal program listings, where, in the “Education TV” broadcasting station, multichannel broadcasting is performed from 11:00 AM until 1:30 PM Given this, the multichannel displaying portion 14 in addition to the “Education TV 1” broadcasting channel name and the “Cooking Today,” “Calisthenics,” “Raising Children,” . . . , broadcast program names, which are displayed in the normal program listings, displays the other broadcasting channel names of “Education TV 2,” and “Education TV 3,” and the broadcast program names of “Classics,” “Italian,” . . . , “Society,” and “Everybody Sing!,” and so forth, which are multichannel broadcasted, in the cells for the time bands at the appropriate broadcasting times.

Consequently, the user, in the normal program listings, can select an arbitrary broadcasting station name (that is, the broadcasting station) to check intuitively, by sight, whether or not there is going to be multichannel broadcasting by that broadcasting station, and, additionally, the time bands and the program names that will be multichannel-broadcasted.

In the example illustrated in FIG. 5, the information for the displayed multichannel broadcast programs can be set so as to display across a specific range of broadcasting times for the broadcasting times of the selected broadcasting station, and, for example, the information for the multichannel-broadcast programs for a limited time interval, such as a range of six hours from the present time, may be displayed, or this information may be displayed across all of the broadcasting times for the selected broadcasting station.

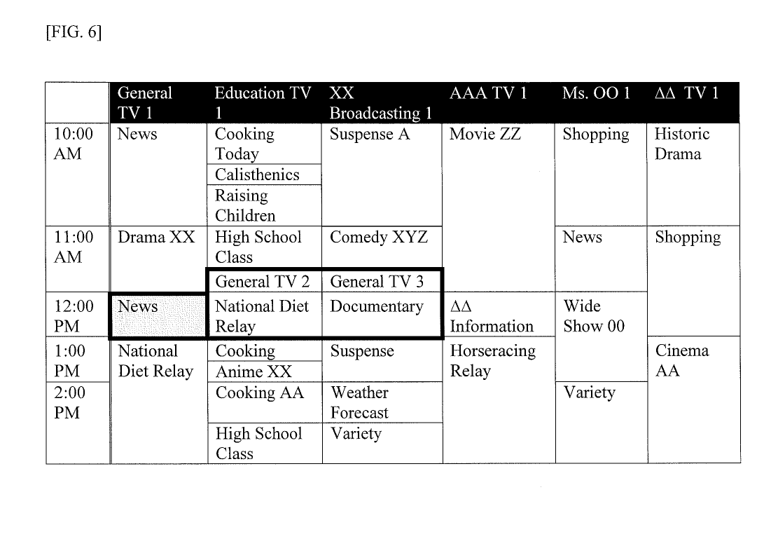

The example illustrated in FIG. 6 is for a case where, in the normal program listings, the cell for the program name “News,” which indicates a broadcast program that is broadcasted on the “General Television 1” broadcasting channel has been selected, where, on this broadcasting station “General Television,” multichannel broadcasting will be performed in a time band starting at 12:00 PM, which is the same as for the selected “News.” Given this, the multichannel displaying portion 14, in addition to the “General Television 1” broadcasting channel that is displayed in the normal programming listing, displays also the other broadcasting channel names of “General Television 2” and “General Television 3,” and the program names “National Diet Relay,” and “Documentary,” thereof, which are multichannel broadcasted, in cells that are adjacent to the selected “News” cell.

Consequently, the user, in the normal program listings, can select an arbitrary broadcast program name (that is, a broadcast channel) to check intuitively, by sight, whether or not there is going to be multichannel broadcasting by that broadcasting station, and, additionally, the names of the programs that will be multichannel-broadcasted starting with the same time band as the selected broadcast program.

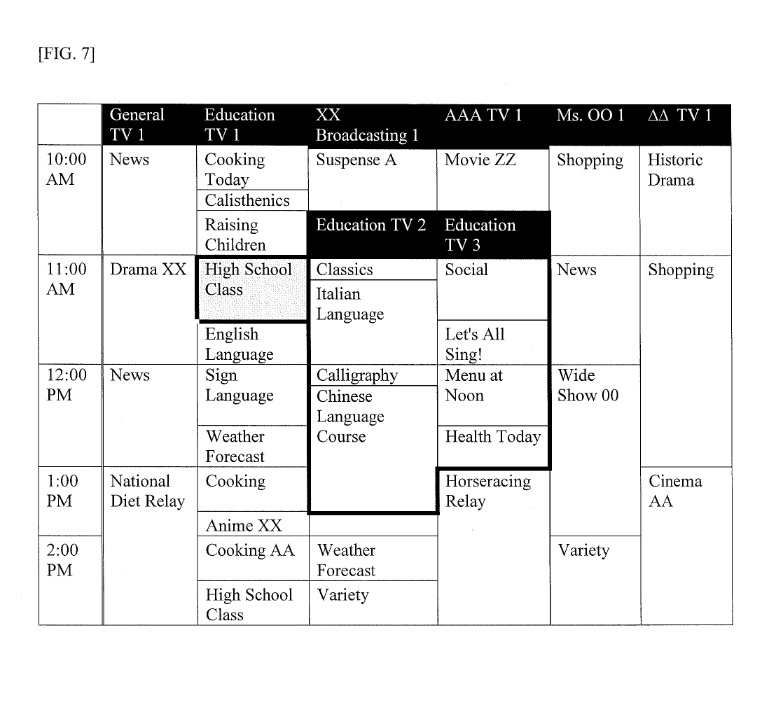

While program names relating to multichannel broadcasting in the same time band as the selected program are displayed in the example in FIG. 6, in one or more embodiments of the present invention, as illustrated in FIG. 7, for example, the system instead may be such that the names of the programs that will be multichannel-broadcasted after the starting time of the applicable broadcast program, using the selected broadcast program as the starting point, may be displayed.

That is, the example in FIG. 7 is for a case wherein the cell for the program name “High School Class,” broadcasted on the broadcast channel “Education TV 1” has been selected, where there will be multichannel broadcasting on the broadcasting station “Education TV” starting at the start time of the broadcast for the selected “High School Class.” Given this, the multichannel displaying portion 14, will display, in addition to the “Education TV 1” broadcasting channel that is displayed in the normal program listings, the other “Education TV 2” and “Education TV 3” broadcasting channel names, and the “Classics,” “Italian,” . . . , “Society,” “Everybody Sing!” broadcast program names, which are to be multichannel-broadcasted, in a series of cells adjacent to the selected “High School Class” cell.

Consequently, the user, in the normal program listings, can select an arbitrary broadcast program name to check intuitively, by sight, whether or not there is going to be multichannel broadcasting by that broadcasting station, and, additionally, the names of the programs that will be multichannel-broadcasted starting with the time band of the selected broadcast program.

Here there may be a case wherein the same broadcast program as the broadcast program displayed in the normal program listings is multichannel-broadcasted, such as in the same program being broadcasted by three SD broadcasts. In such a case, the multichannel displaying portion 14 would not display the multichannel-broadcasted programs, if they are the same program, even if there is multichannel broadcasting related to the broadcast program that has been selected in the normal program listings.

In one or more embodiments, the program information display for the multichannel broadcasting, as described above, by the multichannel displaying portion 14 may use a variety of forms, where, for example, the displaying portion displays the information for programs that are multichannel-broadcasted through being in a different color from the normal program listings, or through a method such as having heavier lines, or highlighting, for the displaying portion for the display of the information of programs that are multichannel-broadcasted. Doing so makes it easier to identify the display of multichannel-broadcasted program information.

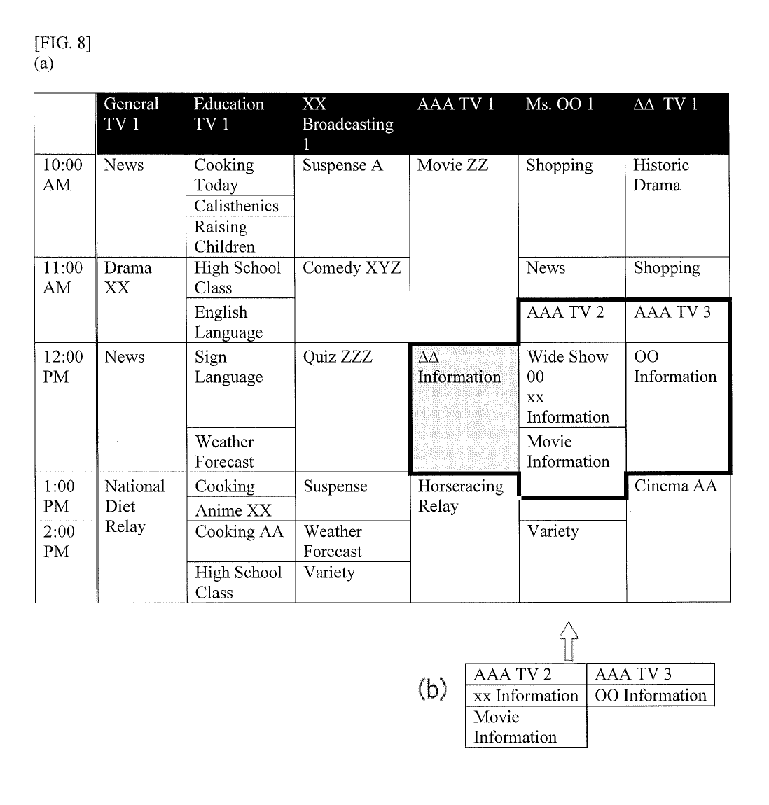

FIG. 8 illustrates another example of a state of the display of multichannel-broadcasted program information.

In this example, as illustrated in FIG. 8 (b), the multichannel displaying portion 14 displays the multichannel-broadcasted program information in a semi-transparent or transparent displaying portion, with this displaying portion displayed overlapping the normal program listings, as shown in FIG. 8 (a).

That is, the example illustrated in FIG. 8 is a case wherein the program name “ΔΔ Information” from “AAA Television 1” has been selected in the normal program listings (FIG. 4), where there is multichannel broadcasting by this broadcasting station “AAA Television.” Given this, the multichannel displaying portion 14 displays the other multichannel broadcasted channel names “AAA Television 2” and “AAA Television 3,” and the broadcast program names of “xx Information,” “Movie Information,” and “00 Information,” displayed in a semi-transparent or transparent displaying portion that overlaps the normal program listings, adjacent to the selected “ΔΔ Information.”

Consequently, the user, in the normal program listings, can select an arbitrary broadcasting station name or broadcast program to check intuitively, by sight, whether or not there is going to be related multichannel broadcasting, and, additionally, the time bands and the program names that will be multichannel-broadcasted. Given this, even when this multichannel broadcast program information is displayed, the normal program listings (which, in the example in FIG. 8, are the “Wide Show 00” on “OO Channel 1” and “Shopping” on “ΔΔ Television 1”) are also visible through the displaying portion for the multichannel broadcast program information, making it possible to provide more information to the user regarding the programs.

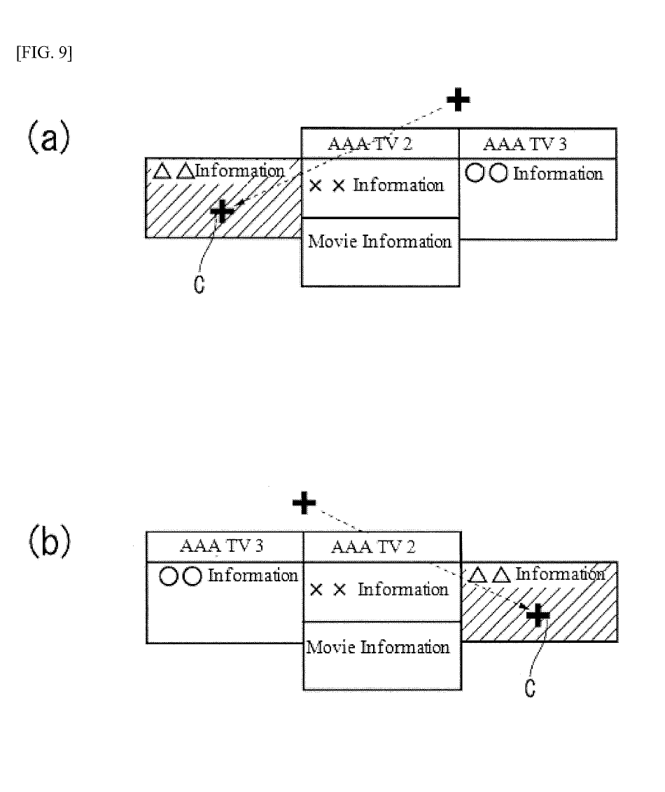

FIG. 9 illustrates another example of a state of the display of multichannel-broadcasted program information.

In this example, the multichannel broadcast program information is displayed in response to a movement of the cursor C that has been moved on the program listings in accordance with a user operation in order to select a broadcasting station or broadcast program. That is, the multichannel displaying portion 14 displays the program information for the multichannel-broadcast program at the side from which the cursor C has moved.

In FIG. 9, the program name “ΔΔ Information” part from “AAA Television 1,” shown in FIG. 4, is shown, where the cursor C is moved through a user operation to select the program name “ΔΔ Information.”

With this program name “ΔΔ Information” there are “xx Information” and “Movie Information” from “AAA Television 2,” and “OO Information” from “AAA Television 3,” as related multichannel broadcast program information, where the multichannel displaying portion 14 displays these multichannel broadcast program information.

At this time, as illustrated in FIG. 9 (a), when the cursor C has been moved from the right side of the “ΔΔ Information” to select “ΔΔ Information,” the multichannel displaying portion 14 displays the multichannel-broadcast program information on the right side of “ΔΔ Information.” Conversely, as illustrated in FIG. 9 (b), when the cursor C has been moved from the left side of the “ΔΔ Information” to select “ΔΔ Information,” the multichannel displaying portion 14 displays the multichannel-broadcast program information on the left side of “ΔΔ Information.”

Consequently, it is possible to display the multichannel broadcast program information at a location anticipated by the user.

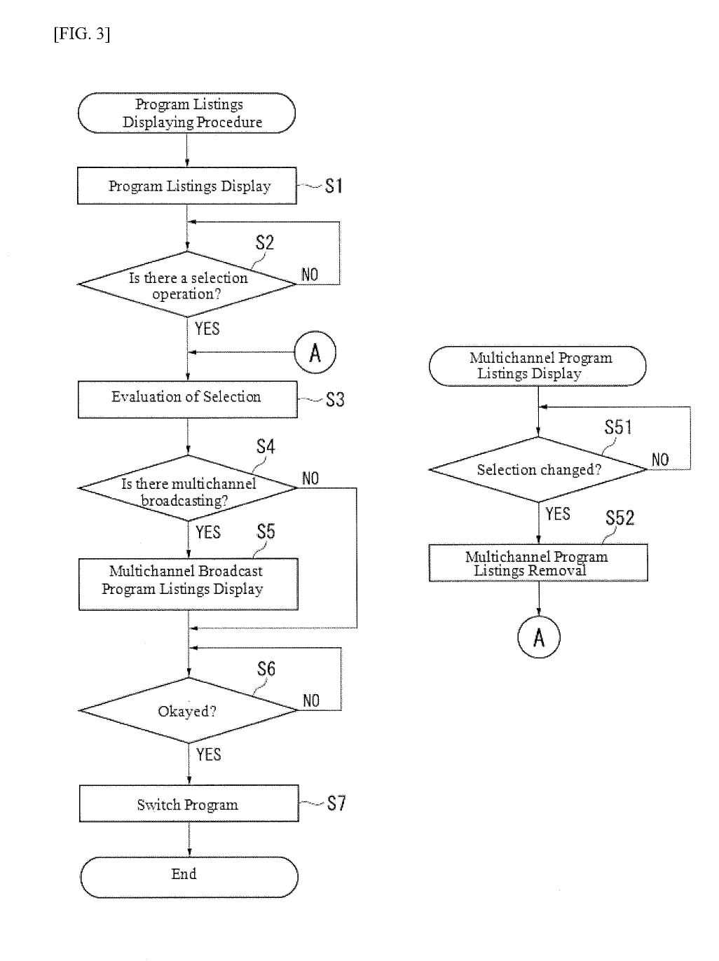

The program listings display set forth above may be achieved through a procedure such as illustrated in FIG. 3.

First, when a user operation is inputted to display the electronic program listings on the screen 2, the program listings displaying portion 12 controls the image processing portion 7 and the display driver 8 to generate the normal program listing (FIG. 4) based on the electronic program guide data, to display them on the screen 2 (Step S1).

When the normal program listings are displayed on the screen, the selection evaluating portion 13 monitors whether or not a user operation for selecting a broadcasting station or broadcast program in the normal program listings has been inputted (Step S2), and if this user operation has been inputted, evaluates which broadcasting station or broadcast program was selected (Step S3).

In accordance with the evaluation, by the selection evaluating portion 13, of the broadcasting station or broadcast program that was selected by the user, the multichannel displaying portion 14 detects, based on the electronic program guide data, whether or not there is multichannel broadcasting in the selected broadcasting station or broadcast program (Step S4), and if there is multichannel broadcasting, displays, on the screen 2, the name of the multichannel-broadcasted broadcast program, as explained based on FIG. 5 through FIG. 9 (Step S5).

Given this, if there was an input to okay the selected broadcast program by a user operation (Step S6), then the display of the screen 2 is switched to the selected and okayed program through the program displaying function of the television receiving device 1 (Step S7).

According to one or more embodiments of the present invention, in the screen displaying procedure for the names of the broadcast programs that are multichannel-broadcasted, described above (Step S5), the selection evaluating portion 13 monitors whether or not the selection has changed, through a user operation input, to another broadcasting station or broadcast program (Step S51), and, in response to an evaluation by the selection evaluating portion 13 that the selection has changed, the multichannel displaying portion 14 removes, from the screen 2, the display of the multichannel broadcast programs which had been displayed on the screen by the previous selection (Step S52), and processing advances to a procedure for evaluating the selection (Step S3).

As a result, the display of the multichannel broadcast programs for the broadcasting station or program from which the selection has changed is removed from the screen 2, making it possible to avoid automatically a situation wherein a useless display remains over the normal program listings, and the multichannel broadcast programs relating to the newly selected broadcasting station or program are displayed on the screen.

While here the explanations have been for an example wherein the electronic program listings displaying device is provided in a television receiving device 1, when provided instead in a television broadcast recording/playing device 3, the screen 2 of the television receiving device 1, for example, may be used as the monitor screen for displaying the program listings, and a signal for displaying the program listings on the screen may be outputted from the television broadcast recording/playing device 3 to the television receiving device 1.

Moreover, the functional portions, such as the controlling portion 11, illustrated in the above, may be structured in hardware, or may be structured through executing a specific program through computer hardware.

While the invention has been described with respect to a limited number of embodiments, those skilled in the art, having benefit of this disclosure, will appreciate that other embodiments can be devised which do not depart from the scope of the invention as disclosed herein. Furthermore, those of ordinary skill in the art would appreciate that certain components or “portions” of one or more embodiments of the present invention may be implemented by a circuit, processor, etc. using known methods. Accordingly, the scope of the invention should be limited only by the attached claims.

### EXPLANATION OF CODES

1: Input Television Receiving Device
2: Screen
3: Television Broadcast Recording/Playing Device
4: Remote Control
5: Antenna
6: Tuner
7: Image Processing Portion
8: Display Driver
9: Operating Portion
10: Receiving Portion
11: Controlling Portion
12: Program Listings Displaying Portion
13: Selection Evaluating Portion
14: Multichannel Displaying Portion
C: Cursor

What is claimed is:

1. An electronic program listings displaying device comprising:
a program listings displaying portion that displays program listings based on electronic program guide data that includes broadcasting channel names and broadcast times for broadcast programs from individual broadcasting stations;
a selection evaluating portion that evaluates a broadcasting station or broadcast program selected in the program listings; and
a multichannel displaying portion that displays multichannel broadcast program information relating to the broadcasting station or broadcast program evaluated by the selection evaluating portion.

2. The electronic program listings displaying device as set forth in claim 1, wherein
the multichannel displaying portion displays the multichannel broadcast program information adjacent to the broadcasting station or broadcast program evaluated by the selection evaluating portion.

3. The electronic program listings displaying device as set forth in claim 1, wherein
the multichannel displaying portion does not display the multichannel broadcast program information when the broadcast program evaluated by the selection evaluating portion is identical to the multichannel broadcast program.

4. The electronic program listings displaying device as set forth in claim 1, wherein
the multichannel displaying portion displays multichannel broadcast program information of a same time band as the broadcast program evaluated by the selection evaluating portion.

5. The electronic program listings displaying device as set forth in claim 1, wherein
the multichannel displaying portion displays, across specific broadcasting times, multichannel broadcast program information relating to the broadcasting station evaluated by the selection evaluating portion.

6. The electronic program listings displaying device as set forth in claim 1, wherein
the multichannel displaying portion displays multichannel broadcast program information starting with a starting time for a broadcast program evaluated by the selection evaluating portion.

7. The electronic program listings displaying device as set forth in claim 1, wherein
the multichannel displaying portion emphasizes display of a display cell that displays multichannel broadcast program information.

8. The electronic program listings displaying device as set forth in claim 1, wherein
the multichannel displaying portion displays the multichannel broadcast program information using a semi-transparent or transparent displaying portion.

9. The electronic program listings displaying device as set forth in claim 1, wherein
the multichannel displaying portion displays the multichannel broadcast program information on a side of the selected broadcasting station or broadcast program from which the cursor was moved in.

10. The electronic program listings displaying device as set forth in claim 2, wherein
the multichannel displaying portion does not display the multichannel broadcast program information when the broadcast program evaluated by the selection evaluating portion is identical to the multichannel broadcast program.

11. The electronic program listings displaying device as set forth in claim 2, wherein
the multichannel displaying portion displays multichannel broadcast program information of a same time band as the broadcast program evaluated by the selection evaluating portion.

12. The electronic program listings displaying device as set forth in claim 3, wherein
the multichannel displaying portion displays multichannel broadcast program information of a same time band as the broadcast program evaluated by the selection evaluating portion.

13. The electronic program listings displaying device as set forth in claim 2, wherein
the multichannel displaying portion displays, across specific broadcasting times, multichannel broadcast program information relating to the broadcasting station evaluated by the selection evaluating portion.

14. The electronic program listings displaying device as set forth in claim 3, wherein
the multichannel displaying portion displays, across specific broadcasting times, multichannel broadcast program information relating to the broadcasting station evaluated by the selection evaluating portion.

15. The electronic program listings displaying device as set forth in claim 2, wherein
the multichannel displaying portion displays multichannel broadcast program information starting with a starting time for a broadcast program evaluated by the selection evaluating portion.

16. The electronic program listings displaying device as set forth in claim 3, wherein
the multichannel displaying portion displays multichannel broadcast program information starting with a starting time for a broadcast program evaluated by the selection evaluating portion.

17. The electronic program listings displaying device as set forth in claim 2, wherein
the multichannel displaying portion emphasizes display of a display cell that displays multichannel broadcast program information.

18. The electronic program listings displaying device as set forth in claim 3, wherein
the multichannel displaying portion emphasizes display of a display cell that displays multichannel broadcast program information.

19. The electronic program listings displaying device as set forth in claim 4, wherein
the multichannel displaying portion emphasizes display of a display cell that displays multichannel broadcast program information.

20. An electronic program listings displaying method comprising:
displaying program listings based on electronic program guide data that includes broadcasting channel names and broadcast times for broadcast programs from individual broadcasting stations;
evaluating a broadcasting station or broadcast program selected in the program listings; and
displaying multichannel broadcast program information relating to the broadcasting station or broadcast program evaluated by the selection evaluating portion.
